(19) United States
(12) Patent Application Publication
(10) Pub. No.: US 2014/0113492 A1
(43) Pub. Date: Apr. 24, 2014

(54) SIMPLIFIED LED MODULES FOR ELECTRICAL AND OPTICAL AUDIO JACKS

(71) Applicant: Apple Inc., Cupertino, CA (US)

(72) Inventors: Joshua Funamura, San Jose, CA (US); Nathan Johanningsmeier, San Jose, CA (US); Niel D. Warren, Soquel, CA (US); Girault W. Jones, San Jose, CA (US)

(21) Appl. No.: 13/913,255

(22) Filed: Jun. 7, 2013

Related U.S. Application Data
(60) Provisional application No. 61/717,631, filed on Oct. 23, 2012.

(51) Int. Cl. H01R 13/66

(52) U.S. Cl. CPC H01R 13/665
USPC 439/620.21

(57) ABSTRACT

Audio jack optical modules that may have a reduced size. Various examples may provide an optical module for an audio jack where a driver circuit is omitted from the optical module and instead placed either elsewhere in the audio jack or separately outside the audio jack. In some examples, the driver may be integrated with a logic circuit, such as a coder-decoder (CODEC) or other logic circuit. Other examples may provide an optical module for an audio jack where a lens for a light-emitting diode is omitted. In some examples, a higher-power light-emitting diode may be used. These light-emitting diodes may be strong enough to provide a requisite amount of light to a detector in, or associated with, an audio plug.

### CROSS-REFERENCES TO RELATED APPLICATIONS

This application is a non-provisional of U.S. provisional patent application Ser. No. 61/717,631, filed Oct. 23, 2012, which is incorporated by reference.

### BACKGROUND

Portable electronic devices, such as portable media players, tablet, netbook, and laptop computers, cell, media, and smart phones, have become ubiquitous in recent years. These devices often include an audio jack through which they receive or provide audio information. The audio jacks may include, or be connected to, electronic circuits such as audio drivers for driving headphones or speakers, audio receivers for receiving audio signals from a microphone, and others. These audio jacks may be arranged to receive an audio plug that may be connected to headphones, speakers, microphones, or other equipment.

These audio plugs may be electrical audio plugs. That is, they may include a number of ring-shaped contacts along their lengths. These contacts may connect to conductors in a cable attached to the audio plug. These contacts may include contacts for left audio, right audio, ground, and microphone. These audio plugs may instead be optical audio plugs, that is, they may have an opening at an end to transmit or receive optical signals.

The audio jacks may include an optical module to transmit or receive optical signals. For example, audio jacks in some devices include optical modules to transmit optical signals. But these optical modules may be relatively large in size. This relatively large size may consume excess board area. This may, in turn, lead to an undesirable increase in the size of the electronic device housing the audio jack. It may also, or instead, limit the functionality that may be included in the electronic device

Thus, what is needed are audio jack optical modules that may have a reduced size.

### SUMMARY

Accordingly, embodiments of the present invention may provide audio jack optical modules that may have a reduced size.

An illustrative embodiment of the present invention may provide an optical module for an audio jack where a driver circuit is omitted from the optical module and instead placed either elsewhere in the audio jack or separately outside the audio jack, for example on a main logic board or other printed or flexible circuit board or appropriate substrate. Removing the driver circuit in this way may reduce the size of an optical module, reduce the number of leads on the optical module, and allow the use of a smaller audio jack. In various embodiments of the present invention, the driver may be integrated with a logic circuit, such as a coder-decoder (CODEC) or other logic circuit.

Another illustrative embodiment of the present invention may provide an optical module for an audio jack where a lens for a light-emitting diode is omitted. In various embodiments of the present invention, a higher-power light-emitting diode may be used. These light-emitting diodes may be strong enough to provide a requisite amount of light to a detector in, or associated with, an audio plug, without the use of a lens.

Another illustrative embodiment of the present invention may provide an electronic device having an audio jack including a reduced-size optical module. The optical module may be reduced in size due to the removal of a driver circuit. The optical module may be instead reduced in size due to the removal of a lens without the removal of the driver. The optical module may be instead reduced in size due to the removal of both a lens and a driver circuit.

In these embodiments of the present invention, the driver may be located elsewhere in the audio jack or separately at a location outside the audio jack. The driver may be located as a separate circuit on a main logic board or other appropriate substrate, or it may be included a part of another logic circuit, such as a coder-decoder (CODEC) or other logic circuit. In such a configuration, an input terminal for a light-emitting diode may connect directly to a terminal for the audio jack. The terminal on the audio jack may connect directly to a trace on the printed circuit board. The trace on the printed circuit board may then connect, either directly or indirectly through one or more other components, to the driver circuit.

Removing the driver may also reduce the number of leads needed on the optical module. Specifically, an optical module with a driver may need a lead for a ground return, a power supply, and a driver input. When the driver is removed, only a lead for either a ground return or power supply (depending on the configuration of the driver circuit) and a lead for an input to the light-emitting diode are needed. The removal of a lead may further simplify and reduce the size of an audio jack using the optical module.

Once the driver circuit is located away from the light-emitting diode, ringing and overshooting in the driving waveform may become a problem due to trace inductances and other parasitics. To improve these waveforms, one or more tuning circuits may be included. These tuning circuits may include one or more resistors, capacitors, active devices, or other components. These tuning circuits may be located between the logic circuit and the driver, the may be located around the driver, they may be located between the driver and the light-emitting diode, or they may be located in some combination of these places. These tuning circuits may be located in a logic device, or they may be located as separate components on a main-logic board or other appropriate substrate.

Embodiments of the present invention may employ a high-power light-emitting diode. This high-power light-emitting diode may be strong enough that a lens is not needed. That is, there may be no need for a lens between the light-emitting diode and an opening of the audio jack. Removing the lens may enable an optical module housing the light-emitting diode to be narrower, which may shorten a length of the audio jack that includes the optical module.

Another illustrative embodiment of the present invention may provide an electronic device. The electronic device may include a main logic board, a first logic circuit located on the main logic board, a tuning circuit located on the main logic board and having a first terminal coupled to an output of the first logic circuit, a driver circuit located on the main logic board and having an input coupled to a second terminal, an audio jack including a first input terminal connected directly to a trace on the main logic board, the trace further coupled to an output of the driver circuit; and a light-emitting diode located in the audio jack, the light-emitting diode having a terminal directly coupled to the first input terminal of the audio jack. A lens for the light-emitting diode may be included or omitted in various embodiments of the present invention.

Another illustrative embodiment of the present invention may provide an electronic device. The electronic device may include a main logic board, a first logic circuit located on the main logic board, an audio jack including a first input terminal connected directly to a trace on the main logic board, the trace further coupled to an output of the first logic circuit, and a light-emitting diode located in the audio jack, the light-emitting diode having a terminal directly coupled to the first input terminal of the audio jack. A lens for the light-emitting diode may be included or omitted in various embodiments of the present invention.

Another illustrative embodiment of the present invention may provide an audio jack. This audio jack may include a housing having an opening, a first terminal to couple to a printed circuit board, and a light-emitting diode having a first terminal connected directly to the first terminal of the audio jack. A lens for the light-emitting diode may be included or omitted in various embodiments of the present invention.

Embodiments of the present invention may provide optical modules for audio jacks that may be included in electronic devices such as portable computers, laptops, tablets, desktops, all-in-one computers, cell phones, smart phones, media phones, storage devices, portable media players, navigation systems, monitors and other devices.

While embodiments of the present invention are well-suited for use with audio jacks having electrical contacts as well as an optical module, embodiments of the present invention are also well-suited for use with optical audio jacks. Also, in various embodiments of the present invention, the optical modules and audio jacks may provide signals consistent with S/PDIF (Sony/Philips Digital Interconnect Format) or other optical formats or standards. Also, while these examples are shown as providing optical modules and circuits for audio output jacks, embodiments of the present invention may be utilized by full duplex or input/output audio jacks as well.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates an electronic device having an audio jack that may be improved by the incorporation of an embodiment of the present invention;

FIG. 2 illustrates an audio jack that may be improved by the incorporation of an embodiment of the present invention;

FIG. 3 illustrates circuitry for an audio system that may be improved by the incorporation of an embodiment of the present invention;

FIG. 4 illustrates an optical module 220 that may be improved by the incorporation of an embodiment present invention;

FIG. 5 illustrates a circuitry for an audio system according to an embodiment of the present invention;

FIG. 6 illustrates circuitry for an audio system according to an embodiment of the present invention;

FIG. 7 illustrates an optical module where a driver circuit has been removed according to an embodiment of the present invention;

FIG. 8 illustrates an audio system according to an embodiment of the present invention;

FIG. 9 illustrates an optical module according to an embodiment of the present invention; and

FIG. 10 illustrates an audio system according to an embodiment of the present invention.

### DESCRIPTION OF ILLUSTRATIVE EMBODIMENTS

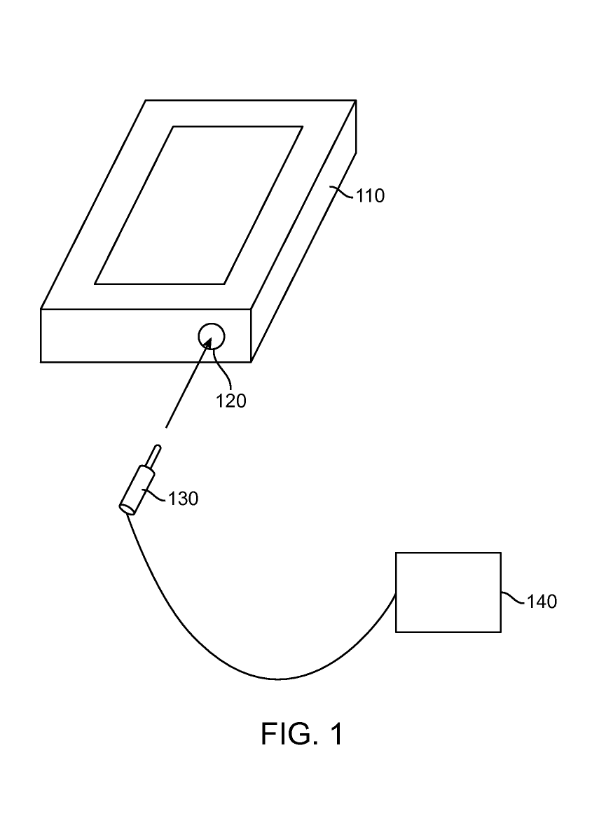

FIG. 1 illustrates an electronic device having an audio jack that may be improved by the incorporation of an embodiment of the present invention. This figure, as with the other included figures, is shown for illustrative purposes only and does not limit either the possible embodiments of the present invention or the claims. Also, the description below may make reference to reference numbers in different figures. To maintain readability, this is not redundantly pointed for each occurrence.

In this specific example, the electronic device may be portable media player 110. Portable media player 110 may include audio jack 120. Audio jack 120 may be arranged to accept audio plug 130. That is, audio plug 130 may be inserted into audio jack 120. Audio plug 130 may further connect to electronic component 140. Electronic component 140 may include headphones, speakers, a microphone, a headset, or other electronic component or components.

While in this example portable media player 110 is shown to include audio jack 120, embodiments of the present invention may provide audio jacks for other types of devices such as portable computers, laptops, tablets, desktops, all-in-one computers, cell phones, smart phones, media phones, storage devices, portable media players, navigation systems, monitors and other devices. Also, while embodiments of the present invention are particularly well-suited for an audio jack, other embodiments of the present invention may be used to improve other types of jacks or receptacles.

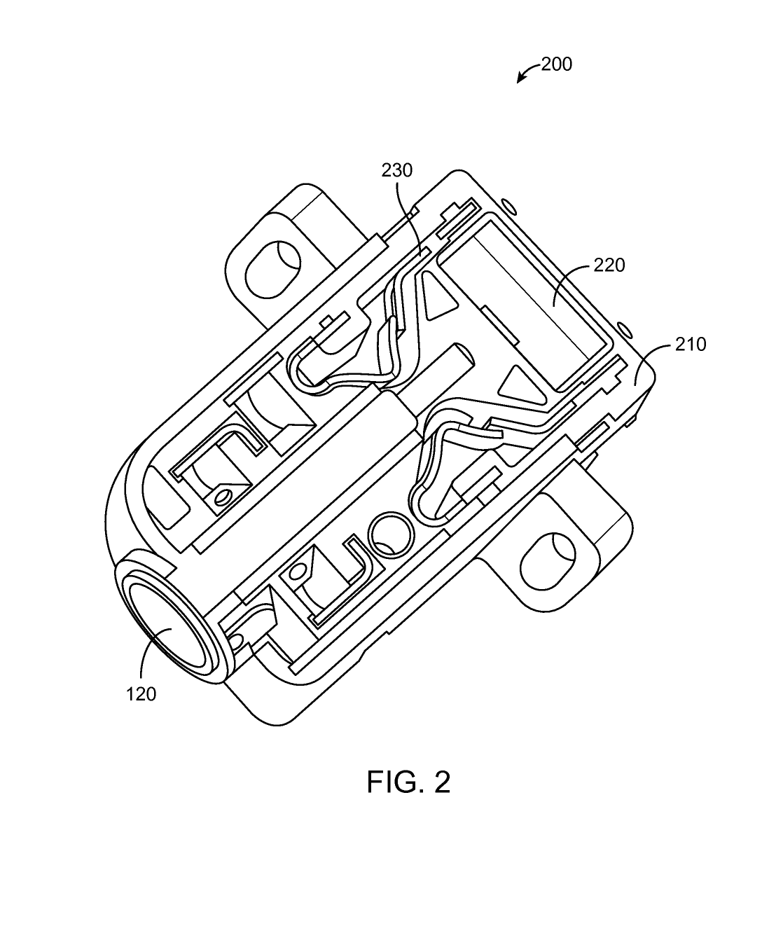

FIG. 2 illustrates an audio jack that may be improved by the incorporation of an embodiment of the present invention. Audio jack 200 may include opening 120 for accepting audio plugs 130. Again, audio plugs 130 may be electrical or optical. Audio jack 200 may include housing 210 supporting a number of electrical contacts 230 and optical module 200. When audio plug 130 is an electrical plug, contacts 230 may make electrical connections with contacts on the electrical audio plug 130 when it is inserted into audio jack 200. When audio plug 130 is optical, optical module 220 may provide optical signals to a detector in optical audio plug 130.

As can be seen, optical module 220 may increase the length of audio jack 200. Optical module 220 may also consume a fair amount of space inside of the object 200. To the extent that optical module 220 may be reduced in size, audio jack 200 may also be reduced in size. This may either permit an electrical device housing audio jack 202 be smaller, or it may allow more functionality to be included in the electronic device, or a combination thereof.

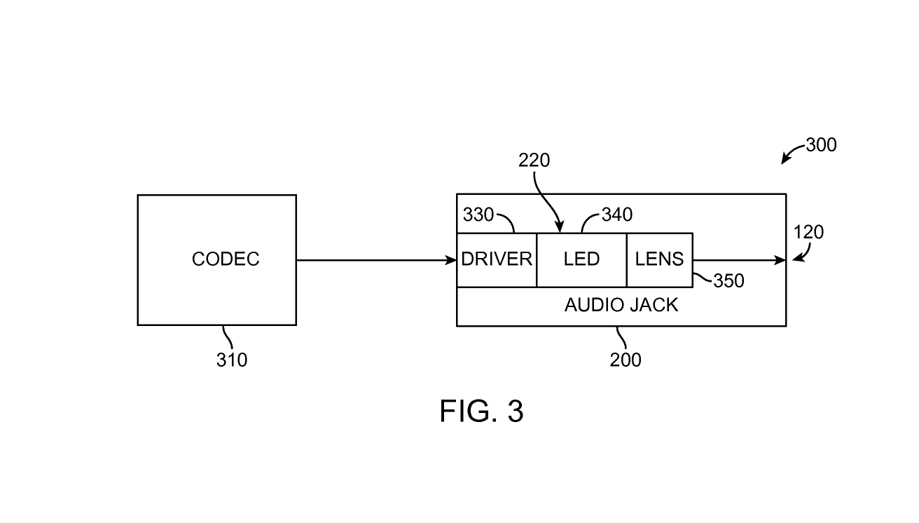

FIG. 3 illustrates circuitry for an audio system that may be improved by the incorporation of an embodiment of the present invention. In this example, an optical module 220 including driver circuit 330, light-emitting diode 340, and lens 350, may be included in audio jack 200.

In audio system 300, a logic circuit, such as a coder decoder 310, may provide an output to driver 330. Driver 330 may drive light-emitting diode 340. Light emitted from light-emitting diode 340 may pass through lens 350 to opening 120 of audio jack 200.

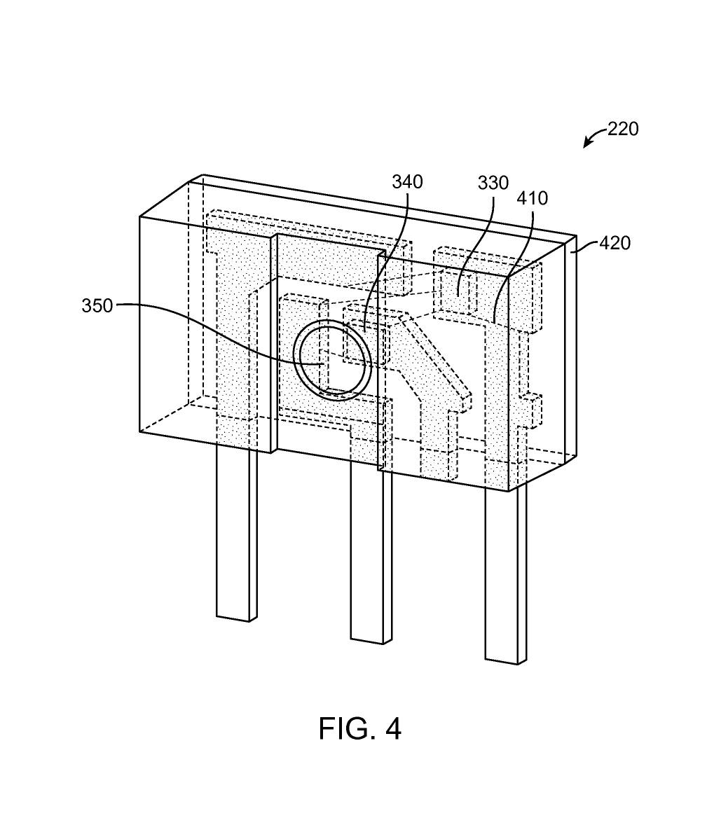

FIG. 4 illustrates an optical module 220 that may be improved by the incorporation of an embodiment present invention. Optical module 220 may include driver circuit 330, light-emitting diodes 340, and lens 350. Traces 410 may provide terminals to circuitry outside optical module 220. Driver 330 and light-emitting diode 340 may reside on board 420.

The optical module shown in this example has three leads. Specifically, leads for an input to the driver, a ground, and a power supply lead are included. These leads may consume space and complicate optical modules. Accordingly, embodiments of the present invention may provide some provide simplified optical modules. Examples are shown in the following figures.

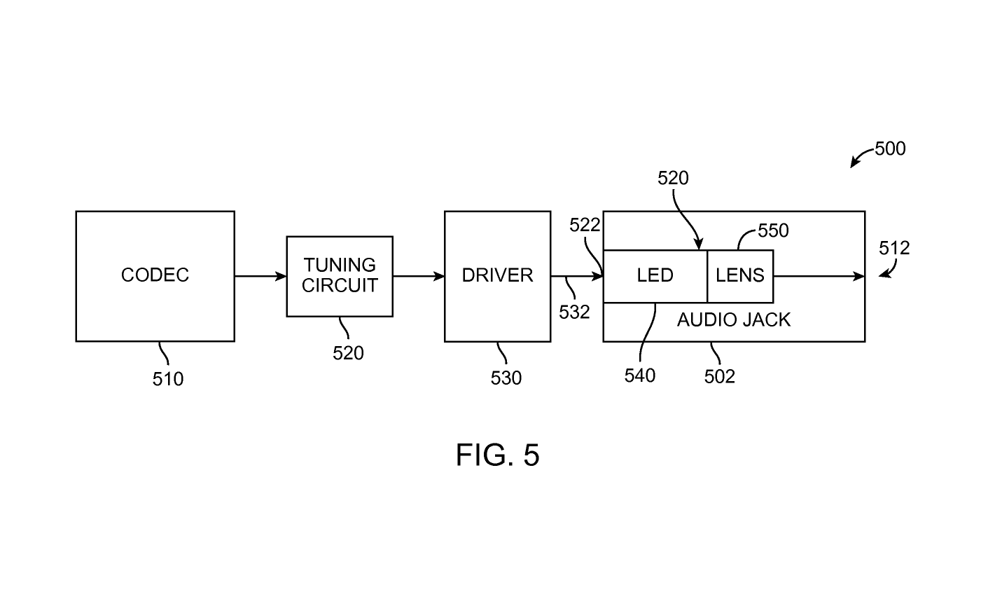

FIG. 5 illustrates a circuitry for an audio system according to an embodiment of the present invention. In audio circuitry 500, driver 530 is shown as being external to audio jack 502. In other embodiments of the present invention, driver 530 may be located elsewhere in audio jack 502. Audio jack 502, as with the other audio jacks in these figures, may be similar to audio jack 200, though a size reduction may be enabled by embodiments of the present invention.

Again, a logic circuit, such as coder decoder 510, may provide an output to driver 530. Driver 530 may provide a waveform or signal on trace 532 to a terminal 522 of audio jack 502. A terminal of light emitting diode 540 in optical module 620 may directly connect to terminal 522 of audio jack 502. Light emitted from light-emitting diode 540 may be focused by lens 550 and passed to opening 520 in audio jack 502.

When a driver, such as driver 530, is removed from an optical module, such as optical module 520, a waveform provided by driver 530 may experience ringing or overshoots due to parasitics in trace 532 and terminal 522. For example, the inductance of trace 532 and terminal 522 may cause an overshoot in a waveform provided by driver 530.

To adjust or improve this waveform, one or more tuning circuits 520 may be provided. In this example, tuning circuits 520 are shown as being placed between CODEC 510 and driver 530. Tuning circuits 520 may include one or more resistors, capacitors, active devices, or combinations thereof. Tuning circuits 520 may be placed between CODEC 510 and driver 530 as shown, between a driver 530 and light-emitting diode 540, around driver 530, or at other locations or combination of locations along the illustrated signal path.

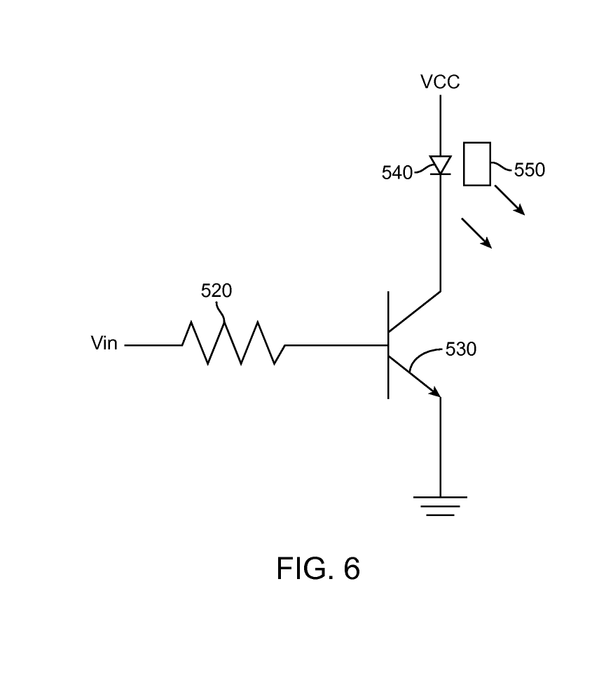

FIG. 6 illustrates circuitry for an audio system according to an embodiment of the present invention. Driver 530 may drive light-emitting diode 540. Light emitted from light-emitting diode 540 may be focused by lens 550. Tuning circuits 520 may be included at an input of driver circuit 530. An input terminal Vin may be driven by a logic circuit, such as a coder decoder or other circuit.

In this example, current may be pulled from a positive power supply VCC through light-emitting diode 540 by driver 530. In other embodiments the present invention other driving configurations may be used. For example, one terminal of light-emitting diode 540 may be connected to ground.

In this example, driver 530 is shown as a simple bipolar transistor. In other embodiments of the present invention, driver 530 may include one or more active devices, and one or more of these active devices may be MOSFETs or other type of transistors.

Again, tuning circuit 520 is shown as being a resistor, though in other embodiments of the present invention, tuning circuit 520 may include one or more resistors, capacitors, active devices, or a combination thereof.

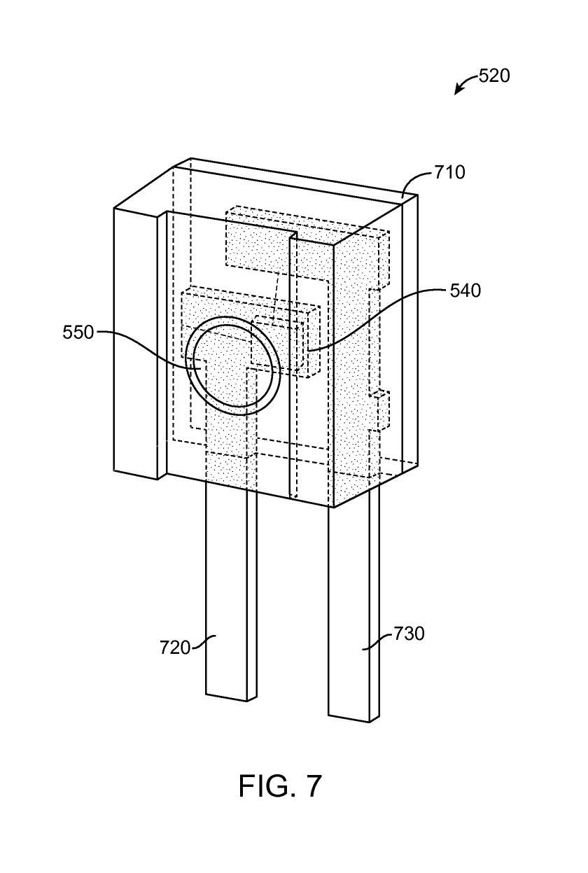

FIG. 7 illustrates an optical module where a driver circuit has been removed according to an embodiment of the present invention. Optical module 520 may include light-emitting diodes 540 and lens 550. Lens 550 may focus light provided by light-emitting diode 540. Light-emitting diode 540 may be supported in optical module 520 by board 710.

Again, a number of leads in optical module 520 has been reduced to two. Specifically, leads 720 and 730 may each be connected either to terminal 522 of audio jack 502, or to a power supply, such as a positive power supply, negative power supply, ground, or other power supply or bias line.

Again, in various embodiments of the present invention, more powerful light-emitting diodes may be used. The use of such a light-emitting diode may eliminate the use of a lens. This in turn may simplify optical modules in audio jacks. Lenses may be omitted in modules were the driver is included, or they may be omitted in modules where the driver has been omitted as well. An example is shown following figures.

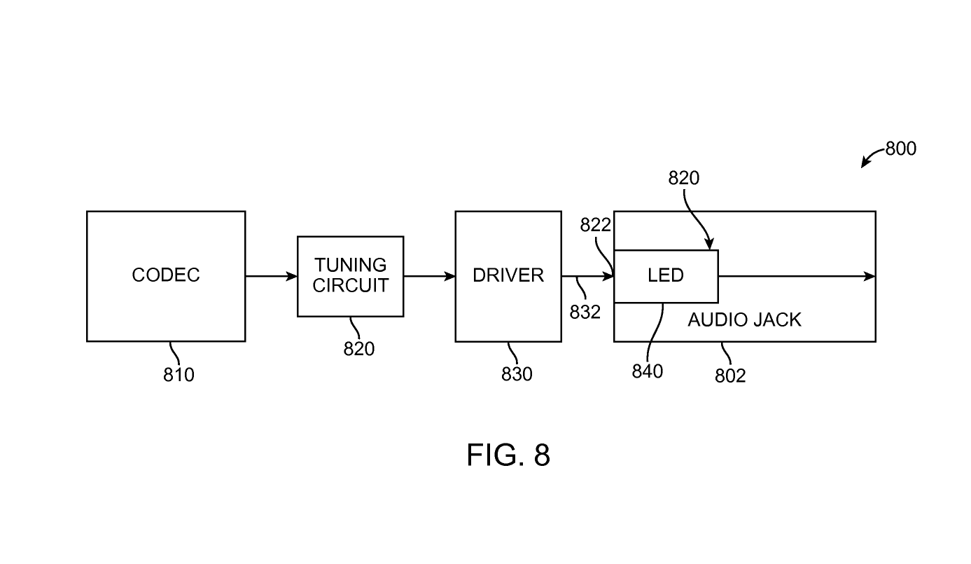

FIG. 8 illustrates an audio system according to an embodiment of the present invention. In this example, optical module 820 has been simplified to include light-emitting diode 840.

In this example, a logic circuit, such as CODEC 810, provides an output signal or waveform to driver 830. This waveform may be provided through tuning circuits 820, as shown. Driver 830 may drive light-emitting diode 840 in audio jack 802. Specifically, driver 830 may connect to trace 832, which may in turn directly connect to terminal 822. Terminal 822 may directly connect to a terminal of light-emitting diode 840.

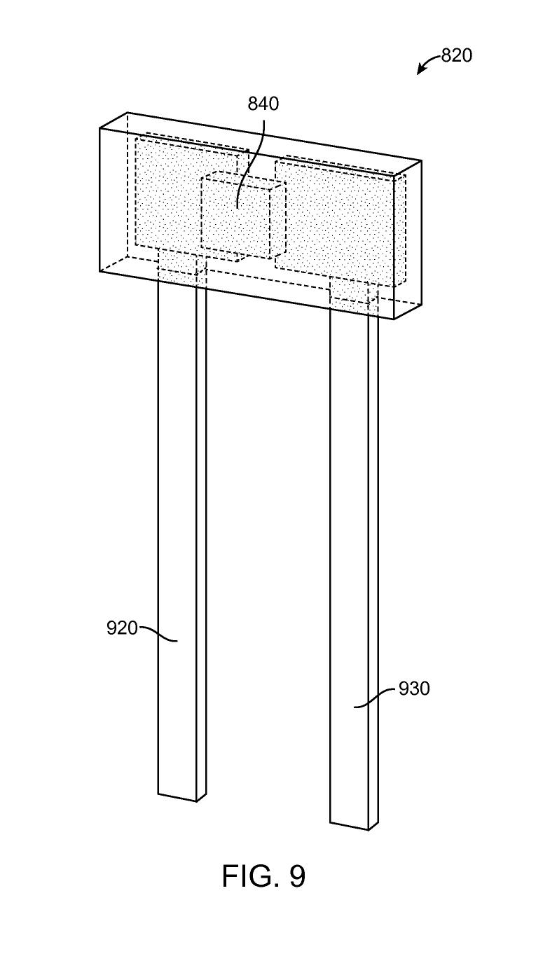

FIG. 9 illustrates an optical module according to an embodiment of the present invention. Optical module 820 may include light-emitting diode 840. In this example, a board is omitted from optical module 820, though one could be included consistent with embodiments of the present invention. Leads 910 and 920 may be terminals for light-emitting diode 840.

In various embodiments of the present invention, one of these leads may in turn connect directly to terminal 822 in audio jack 802, while the other may couple to a power supply, such as a positive power supply, negative power supply, ground, or other power supply.

Again, in various embodiments of the present invention, driver circuits may be integrated along with other logic circuitry. Also, tuning components, if necessary, may also be integrated. An example is shown in the following figure.

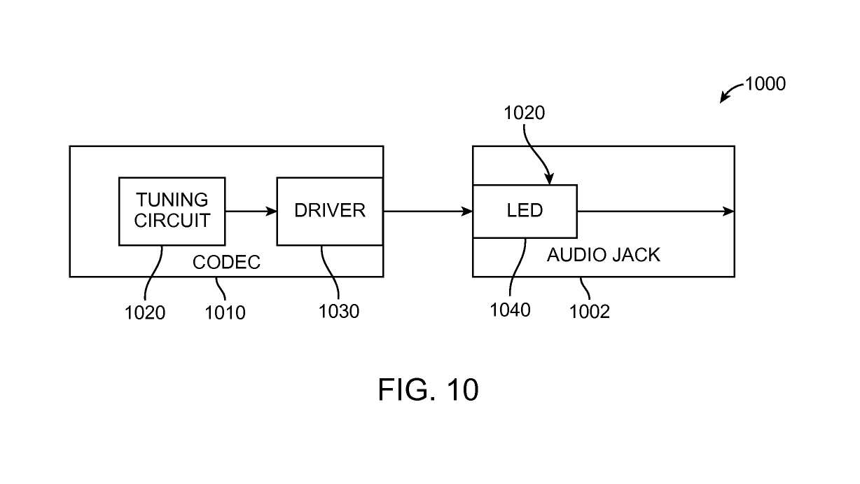

FIG. 10 illustrates an audio system according to an embodiment of the present invention. In audio system 1000, driver 1030 may be integrated into a logic circuit, specifically coder-decoder or CODEC 1010. Tuning circuits 1020 may also be included as part of CODEC 1010. Driver 1030 in CODEC 1010 may drive light-emitting diode 1040 in optical module 1020 in audio jack 1002.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. An electronic device comprising:
a main logic board;
a first logic circuit located on the main logic board;
a tuning circuit located on the main logic board and having a first terminal coupled to an output of the first logic circuit;
a driver circuit located on the main logic board and having an input coupled to a second terminal;
an audio jack including a first input terminal connected directly to a trace on the main logic board, the trace further coupled to an output of the driver circuit; and
a light-emitting diode located in the audio jack, the light-emitting diode having a terminal directly coupled to the first input terminal of the audio jack.

2. The electronic device of claim 1 wherein the first logic circuit comprises a coder-decoder circuit.

3. The electronic device of claim 1 wherein the tuning circuit comprises a resistor.

4. The electronic device of claim 1 wherein the tuning circuit comprises a resistor and a capacitor.

5. The electronic device of claim 1 wherein the driver circuit comprises a MOSFET transistor.

6. The electronic device of claim 1 wherein the driver circuit comprises a bipolar transistor.

7. The electronic device of claim 1 further comprising a lens located between the light-emitting diode and an opening of the audio jack.

8. The electronic device of claim 1 wherein there is an absence of a lens located between the light-emitting diode and an opening of the audio jack.

9. The electronic device of claim 1 wherein there is no lens located between the light-emitting diode and an opening of the audio jack.

10. An electronic device comprising:
a main logic board;
a first logic circuit located on the main logic board;
an audio jack including a first input terminal connected directly to a trace on the main logic board, the trace further coupled to an output of the first logic circuit; and
a light-emitting diode located in the audio jack, the light-emitting diode having a terminal directly coupled to the first input terminal of the audio jack.

11. The electronic device of claim 10 further comprising a lens located between the light-emitting diode and an opening of the audio jack.

12. The electronic device of claim 10 wherein there is an absence of a lens located between the light-emitting diode and an opening of the audio jack.

13. The electronic device of claim 10 wherein there is no lens located between the light-emitting diode and an opening of the audio jack.

14. The electronic device of claim 10 wherein the logic circuit comprises a driver circuit.

15. The electronic device of claim 14 wherein the driver circuit comprises a MOSFET transistor.

16. The electronic device of claim 14 wherein the driver circuit comprises a bipolar transistor.

17. An audio jack comprising:
a housing having an opening;
a first terminal to couple to a printed circuit board; and
a light-emitting diode having a first terminal connected directly to the first terminal of the audio jack.

18. The electronic device of claim 17 further comprising a lens located between the light-emitting diode and an opening of the audio jack.

19. The electronic device of claim 17 wherein there is an absence of a lens located between the light-emitting diode and an opening of the audio jack.

20. The electronic device of claim 17 wherein there is no lens located between the light-emitting diode and an opening of the audio jack.
